(19) United States
(12) Patent Application Publication
(10) Pub. No.: US 2025/0265683 A1
(43) Pub. Date: Aug. 21, 2025

(54) IMAGE RECONSTRUCTION AND PROCESSING

(71) Applicant: Commissariat à l'Energie Atomique et aux Energies Alternatives, PARIS (FR)

(72) Inventor: William GUICQUERO, GRENOBLE (FR)

(21) Appl. No.: 19/047,228

(22) Filed: Feb. 6, 2025

(30) Foreign Application Priority Data
Feb. 15, 2024 (FR) 2401481

(51) Int. Cl. G06T 5/70; G06T 3/4015; G06T 5/60

(52) U.S. Cl. CPC G06T 5/70; G06T 3/4015; G06T 5/60; G06T 2207/20081; G06T 2207/20084

(57) ABSTRACT

The present description concerns a method of training a neural network (202) comprising: the generation of a modified image, by a modified data generator, based on a first image, the modified image comprising at least one outlier pixel value with respect to the first image; the supplying of the modified image to the network; the generation, by the network, of a corrected image; the supplying of the corrected image, by the network, and the supplying of an indication of the position of the at least one modified pixel, by the generator, to a computing circuit (210) the generation of an error value, based on the application of a loss function, by the computing circuit, taking as inputs the first image, the indication, and the corrected image; the correction of parameters associated with the network by backpropagation of the error in the network.

### FIELD

The present disclosure generally concerns methods and devices for the reconstruction and the processing of images, and in particular methods and devices for image demosaicing.

### BACKGROUND

In Raw images acquired by image sensors, such as for example image sensors dedicated to visible and/or infrared imaging, exhibit alterations due to malfunctions of the sensors. In particular, image sensors implementing canonical imaging systems, using unit pixel mosaicing methods, may exhibit, within their lifetime, malfunctions on isolated pixels, or on pixel columns and/or losses of captured data for isolated pixels or pixel columns.

It is desirable to improve the processing and the reconstruction of images acquired by sensors comprising dysfunctional pixels.

### SUMMARY

An embodiment provides a method of training a neural network configured to perform image processing operations, the method comprising:
the generation of a modified image, by a modified data generator, based on a first image, the modified image comprising at least one outlier pixel value with respect to the first image;
the supplying of the modified image to the network;
the generation, by the network, of a corrected image;
the supplying of the corrected image, by the network, and the supplying of an indication of the position of the at least one modified pixel, by the generator, to a computing circuit
the generation of an error value, based on the application of a loss function, by the computing circuit, taking as inputs the first image, the indication, and the corrected image;
the correction of parameters associated with the network by backpropagation of the error in the network.

According to an embodiment, the generation of the corrected image by the network comprises:
the generation, by a first sub-module, of an intermediate data value based on the modified image, the intermediate data item being an at least partial reconstruction of the first image;
the generation, by a second sub-module of the network, of an attention data item based on one of the intermediate data item and/or of the modified image, the attention data item comprising an estimate of the location of the at least one modified pixel;
the generation of the corrected image, by the first sub-circuit or by a third sub-circuit, based on the intermediate data item and on the indication data item.

According to an embodiment, the generation of the attention data item comprises the execution of a convolutional neural network configured for image segmentation, based on the intermediate data item and/or on the corrected image.

According to an embodiment, the convolutional neural network is a network of U-net type or a variant of network of U-net type.

According to an embodiment, the generation of the attention data further comprises a normalization of NL1 standard type, based on the data item generated by the convolutional neural network.

According to an embodiment, the generation of the corrected image comprises a multiplexing operation and/or a multiplication operation, for example a pointwise multiplication, based on the attention data item and on the intermediate data item.

According to an embodiment, the generation of an error value comprises the application of a focal loss function taking, as input data, the modified image, the first image, and the indication of the location of the at least one modified pixel.

According to an embodiment, the generation of an error value further comprises the application:
of a loss function based on an averaging taking, as input data, the modified image and the first image; and/or
of a regularization function taking, as input data, the modified image.

According to an embodiment, the first image is comprised in a database.

According to an embodiment, the generation of the modified image comprises, for each pixel:
the determination of whether the pixel is to be modified; and
if the pixel is to be modified, the replacing of the value associated with the pixel by an outlier.

According to an embodiment, the generation of the modified image, by the modified data generator, is further performed based on a mosaic pattern.

According to an embodiment, the model of the modified data generator is a neural network model previously trained for modified image generation, and configured for the implementation of so-called “style transfer” techniques.

An embodiment provides an image processing method comprising:
the capturing of an image scene, by an imager of an image processing device, the captured image being an image mosaiced according to a mosaic pattern
the supplying of the mosaiced image to a neural network of the processing device trained according to the above training method; and
the generation of a corrected image, by the network, based on the mosaiced image.

According to an embodiment, the generation of the corrected image by the network comprises:
the supplying of the mosaiced image to a first sub-module of the network configured to generate an intermediate data item by performing a first demosaicing of the mosaiced image;
the supplying of the intermediate data item to a second sub-module of the network configured to generate an attention data item based on the intermediate data item, the attention data item comprising estimates of the location of dysfunctional pixels of the imager; and
the generation of the corrected image, by a third sub-module, based on the intermediate data item and on the attention data item.

According to an embodiment, the mosaic pattern corresponds to a mosaic pattern used during the generation of a modified image during the training of the network.

An embodiment provides an image processing device comprising:
an imager configured to capture image scenes, according to a mosaic pattern;
a neural network trained according to the above training method, configured to generate a corrected image based on the mosaiced image.

According to an embodiment, the imager comprises one or a plurality of dysfunctional pixels.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows examples of mosaic patterns implemented by image sensors;

FIG. 2 is a block diagram illustrating a neural network training architecture, according to an embodiment of the present disclosure;

FIG. 3 is a block diagram illustrating a architecture of the network configured to perform inference operations, according to an embodiment of the present disclosure;

FIG. 4 is an example of architecture of a processing network, according to an embodiment of the present disclosure;

FIG. 5 is an example of architecture of an attention module, according to an embodiment of the present disclosure; and

FIG. 6 is an example of architecture of a processing network, according to an embodiment of the present disclosure.

### DETAILED DESCRIPTION OF THE PRESENT EMBODIMENTS

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, the operation and the implementation of different types of neural network layers, such as dense layers, convolutional layers, etc., are not described in detail and are known to those skilled in the art.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

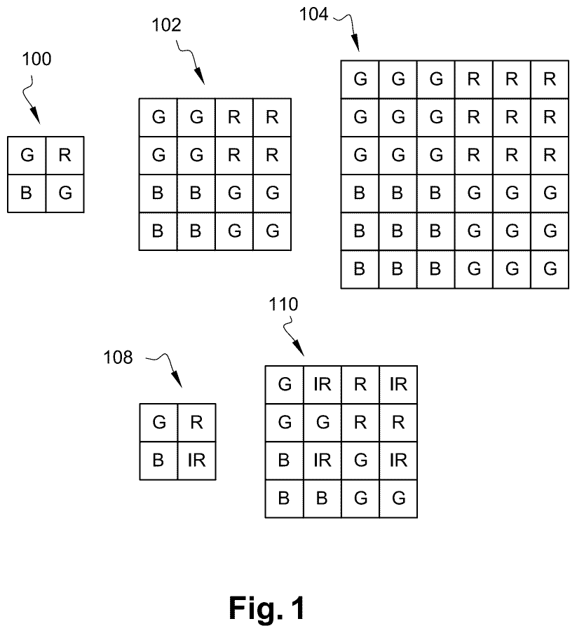

FIG. 1 examples of mosaic patterns implemented by image sensors, or imagers.

A mosaic pattern is a pattern comprising a plurality of pixels and acting as a replicated spectral filter, mosaic, on the surface of an imager. The imager then measures, for each pixel in the mosaic, a value associated with a channel defined by the mosaic pattern. The mosaic pattern indicates, for each pixel, which single channel among, for example, color and/or infrared channels is measured. As an example, each pixel has a spectral signature determining a wavelength interval comprising the spectral response recorded by the pixel.

In the example of FIG. 1, a mosaic pattern 100 is a Bayer-type pattern. This pattern has a 2×2-pixel size and enables to measure the wavelengths associated with the green color (G) for the pixels at the top left and at the bottom right of the pattern. The Bayer pattern further enables to measure the wavelengths associated with the red color (R) of the pixel at the top right, as well as to measure the wavelengths associated with the blue color (B) at the bottom left of the pattern.

A mosaic pattern 102 is a QuadBayer-type pattern. This pattern has a 4×4-pixel size and enables to measure the wavelengths associated with the green color (G) for the four pixels at the top left and at the bottom right of the pattern. Pattern 102 further enables to measure the wavelengths associated with the red color (R) for the pixels at the top right, and as well as to measure the wavelengths associated with the blue color (B) for the four pixels at the bottom left of the pattern.

A pattern 104 is a pattern of 3-cell Bayer type. This pattern has a 6×6-pixel size and has the same structure as patterns 100 and 102, except that the red, green, and blue color channels are measured in groups of 3×3 pixels.

A pattern 108 is a pattern of 2×2 RGBIR type. This pattern has a 2×2-pixel size and enables to measure the wavelengths associated with the green color for the pixel at the top left of the pattern. Pattern 108 further enables to measure the wavelengths associated with the blue color of the pixel at the top right, and to measure the wavelengths associated with the red color at the bottom left of the pixel. Pattern 108 further enables to measure the wavelengths associated with the infrareds (IR) of the pixel at the bottom right.

A pattern 110 is a pattern of 4×4 RGBIR type. This pattern has a 4×4-pixel size and enables to measure the wavelengths associated with the green color of the first pixel, starting from the left in the first row, of the third pixel, starting from the left in the third row, of the first and second pixels, starting from the left in the second row, and of the third and fourth pixels, starting from the left in the fourth row. Pattern 110 further enables to measure the wavelengths associated with infrareds of the second and fourth pixels, starting from the left of the first and third rows. Pattern 110 further enables to measure the wavelengths associated with the blue color of the first pixel, starting from the left of the third row, and of the first and second pixels, starting from the left of the fourth row, as well as to measure the wavelengths associated with the red color of the third pixel, starting from the left of the first row, and of the third and fourth pixels, starting from the left of the second row.

These examples of mosaic patterns are given as an example and are of course not limiting. Other mosaic patterns having different size and arrangements may of course be envisaged. In other examples, the mosaic pattern replicated on the imager surface comprises a pixel configured to measure a distance between one or a plurality of targets in the captured scene and the imager. Such imagers are color image sensors further enabling to capture so-called depth information, it is then spoken of monolithic RGBZ imagers.

A raw image captured by the imager comprises, for example, for each pixel, a single measured value. The demosaicing then consists of estimating, for each pixel, the value of the non-measured channels by using, for example, the spectral correlation between the measured channels as well as the spatial correlation between the value of a same channel for two adjacent pixels.

However, there may happen for certain pixels to be dysfunctional. As an example, one or a plurality of isolated pixels may become saturated or unusable. It will then be spoken of a dead pixel. As an example, the so-called dark signal, representing a type of noise in the absence of a luminous flux, measured for isolated pixels is outside the nominal statistics, and the measurements associated with these pixels are then aberrant. Other noise sources may cause an aberrant behavior on a pixel or on a group of pixels. As an example, certain isolated pixels are subject to random telegraphic signal (RTS) noise. As an example, as a result of a malfunction of an imager readout circuit, pixel columns are missing, or clamped. In other examples, a digital fault, such as for example a loss of synchronization in measurements, or a bit-flip, causes a loss of data associated with isolated pixels and/or columns and/or rows of pixels and/or one or a plurality of pixel frames. In the following, there will be called bad pixel any dysfunctional pixel, whether it is isolated or in a dysfunctional column, row, or frame. Measurements associated with bad pixels are then aberrant or outlier measurements, not approaching reality.

Further, bad pixels will, for example, influence the estimation of adjacent pixels during demosaicing. As an example, the final image, obtained as a result of a demosaicing which does not correct bad pixels, will for example exhibit black spots having a greater size than the bad pixel or the group of bad pixels

However, outlier measurements associated with bad pixels are relatively infrequent. Indeed, the above-mentioned malfunctions generally have a low occurrence rate, in the order of 1/1000 or less. However, in imagers comprising a very large number of pixels, these malfunctions may be impacting in terms of on visual rendering and for the perception of the image. As an example, these malfunctions impact image rendering in much more visible fashion than disturbances due to homoscedastic noise having a distribution centered around zero.

When a deep neural network is trained to demosaic raw images, outlier measurements, associated with bad pixels, are drowned out by other noise, due to their rare occurrence. Further, conventional loss functions, mainly based on average calculations and canonically applying regardless of the pixel position, fail to identify and correct this type of outliers.

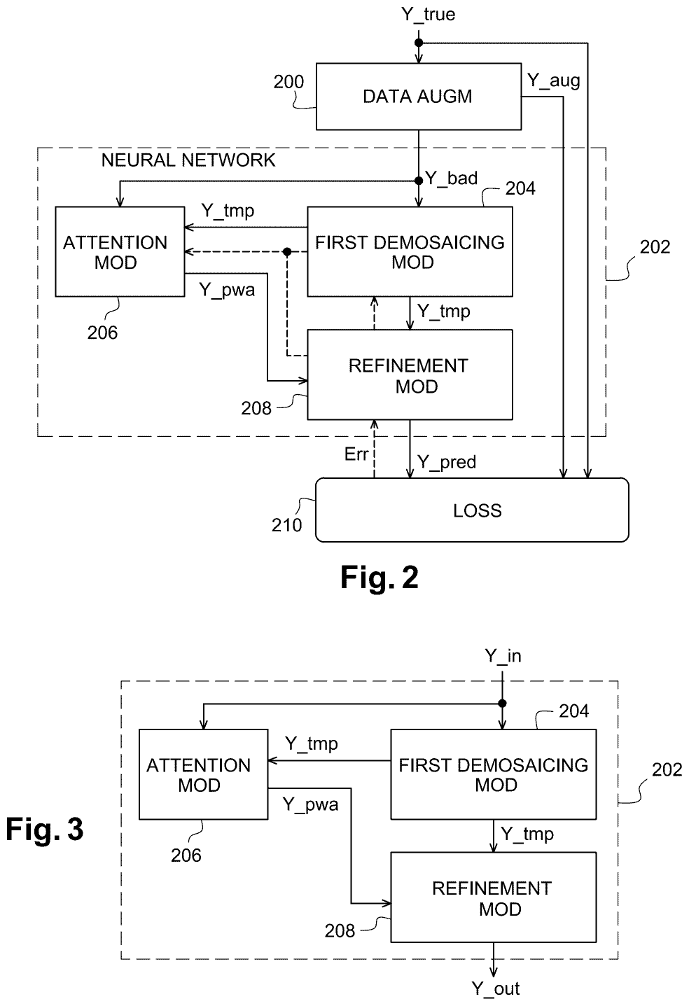

FIG. 2 is a block diagram illustrating a training architecture of a deep neural network, according to an embodiment of the present disclosure. In particular, the training of the neural network described in relation with FIG. 2 enables to taken into account outliers, for example due to bad pixels, in image reconstruction.

According to an embodiment, an augmentation module 200 (DATA AUGM) enables, for example, the execution of a data augmentation model. As an example, module 200 is configured to receive, as input data, an image Y_true corresponding to a ground truth, that is, to an image comprising no error resulting from any processing. As an example, each pixel of image Y_true comprises the ground truth values of a plurality of channels. Module 200 is further configured to generate a modified image Y_bad, based on image Y_true. The modified image Y_bad then corresponds to image Y_true, in a mosaic format, to which are added one or a plurality of outliers.

As an example, module 200 is configured to model noise such as pixel readout and column readout noise, photonic noise, fixed pattern noise, for example structured, random telegraphic noise, and dead or saturated pixels.

As an example, module 200 is configured to add to each pixel, with a probability at most equal to 1/1,000, an outlier. In other words, module 200 performs, pixel by pixel, a Bernoulli test, with parameter p, where p is at most equal to 1/1,000. When the Bernoulli test is successful, module 200 is configured to modify the value of the associated pixel into an outlier. When the test fails, in the majority of cases, the pixel value remains identical to that of image Y_true. In another example, when the test fails, one or a plurality of noises are added to the pixel value. As an example, the outlier is a constant value. In another example, the outlier originates, for each concerned pixel, from a random draw. The outlier is for example added to the value measured for said pixel. In another example, the outlier is multiplied by the value measured for said pixel. Still in another example, the outlier is substituted for the value measured for said pixel. In another example, for each concerned pixel, a plurality of outliers are for example determined, randomly or not, and the measured value of the pixel is replaced with a combination of at least one addition of an outlier with the measured value and/or of a multiplication of an outlier by the measured value.

As an example, the generation of the outlier is performed according to a strongly pitted probability distribution, that is, having a high 4th-order moment, such as for example a Laplace distribution, a Cauchy distribution, etc.

The methods and circuits for the generation of such a modified image are known to those skilled in the art, and the given example of generation is of course not limiting.

Module 200 is further configured to generate a data item Y_aug, for example taking the form of a tensor, comprising indications of the positions of the modified pixels. As an example, data item Y_aug further comprises an indication of the outliers having been assigned.

As an example, the field images, supplied to module 200 are comprised in a pre-stored database, for example in a non-volatile memory, such as a server, etc.

Module 200 is for example configured to supply the modified image Y_bad to a neural network 202 (NEURAL NETWORK) in order to train it. As an example, network 202 is configured to perform regression tasks in order to reconstruct and demosaic a mosaiced image being supplied thereto, while taking into account possible bad pixels. As an example, network parameters, such as weights etc., are initially set to initial values.

According to an embodiment, the mosaic pattern used by module 200 to mosaic image Y_true corresponds to the mosaic pattern which will be used by an image sensor of a device comprising trained network 202.

According to another embodiment, module 200 comprises a neural network previously trained to generate images, such as for example mosaiced images. As an example, image generation is performed by means of so-called “style transfer” techniques, such as, for example, the techniques described in the publication “Unsupervised Image-to-Image Translation: A review” by Hoyer, H. et al. and published in Sensors in 2022 and/or in the popularization article on GAN cycles “A Gentle Introduction to CycleGAN for Image Translation” written by Brownlee, J., Aug. 17, 2017.

Network 202 comprises, for example, a processing sub-module 204 (FIRST DEMOSAICING MODULE) configured to generate an intermediate data item Y_tmp, based on the modified image Y_bad. The intermediate data item Y_tmp corresponds, for example, to a first demosaicing and reconstruction of the image. As an example, module 204 is a convolutional network integrating a plurality of neural layers.

Network 202 further comprises, for example, an attention sub-module 206 (ATTENTION MOD) configured to receive the intermediate data item Y_tmp, or a sub-part thereof, supplied by module 204 and/or the modified image Y_bad supplied by augmentation module 200. Sub-module 206 is further configured to generate an attention data item Y_pwa having, for example, the form of a tensor. Data item Y_pwa is generated by sub-module 206 so as to carry the information of the modified image pixel by pixel. In particular, sub-module 206 is designed to implement, first, a pixel-by-pixel segmentation of the image, in order to determine pixel by pixel a type of demosaicing to be performed. Sub-module 206 is further configured to generate data item Y_pwa in such a way that it comprises information about a type of processing to be carried out pixel by pixel, such as for example a gating operation. The gating is for example performed on the data of tensor Y_tmp by means of signal Y_pwa, in order to weight each type of reconstruction present in tensor Y_tmp according to tensor Y_pwa.

Network 202 for example further comprises a refinement sub-module 208 (REFINEMENT MOD). As an example, sub-module 208 is configured to generate a corrected image Y_pred based on the intermediate data item Y_tmp supplied by sub-module 204 and on the attention data item Y_pwa supplied by sub-module 206.

In another example, sub-module 208 is configured to perform an Y_tmp gating in the axis of the channels, based on data item Y_pwa.

During the training of network 202, the corrected image Y_pred is supplied to a computing circuit 210 (LOSS). Computing circuit 210 is further configured to receive ground truth image Y_true and the data item Y_aug comprising the indications of the positions where the outliers have been added by module 200.

As an example, data item Y_aug is a tensor having a value in \{0,1\}, the pixels assigned to value 1 indicating for example the positions of bad pixels.

According to an embodiment, computing circuit 210 is configured to calculate an error value Err by applying a loss function to the modified image Y_pred, ground truth image Y_true, and data item Y_aug. As an example, the loss function applied by calculation circuit 210 combines a plurality of fidelity loss functions, such as a loss function based on mean error calculations without bias and applied between data Y_pred and Y_true, or a focal loss function (LFF) applied to the data Y_pred, Y_true, and Y_aug for which the focusing is, for example, controlled by tensor Y_aug. As an example, the loss function applied by computing circuit 210 further comprises a regularization function applied only to the corrected image Y_pred. As an example, the regularization function is determined based on assumptions as to the nature of the signal of the corrected image Y_pred.

As an example, the error value is such that Err=λ_{LFM}×LFM(Y_pred, Y_true)+λ_{LFF}×LFF(Y_pred, Y_true, Y_aug)+λ_{LR}×LR(Y_pred) where function LFM is a loss function based on mean error calculations, for example based on mean square error calculation, function LFF is a focal loss function, and function LR is a regularization function, and where λ_{LFM}, λ_{LFF}, and λ_{LR} are weighting coefficients. For example, coefficients λ_{LFM}, λ_{LFF}, and λ_{LR} are used to emphasize the importance of one loss function over another.

As an example, the mean error LFM(Y_pred, Y_true) is such that

$$\begin{matrix}LFM ( Y\_pred , Y\_true ) = {λ}_{1} \sum \vert CNN ( Y\_pred ) - CNN ( Y\_true ) \vert \\ + {λ}_{2}^{2} \sqrt{{\vert CNN ( Y\_pred ) - CNN ( Y\_true ) \vert}^{2}} ,\end{matrix} \qquad [ Math 1 ]$$

where CNN (⋅) is an intermediate output of a neural network model having been previously trained to perform certain inference tasks. As an example, CNN(⋅) has been trained in supervised fashion so as to feed a sub-model dedicated to image classification tasks. For example, the neural network is based on a latent space derived from a neural network model trained to perform classification operations on databases, such as for example the ImageNET database. As an example, function CNN(⋅) is a function vgg(⋅) where vgg(⋅) is a function returning a latent space, for example of type vgg16, coefficients λ₁ and λ₂ are weighting coefficients between distance calculations of L1 and L2 type. In particular, the sum is performed on all elements, that is, on all pixels and all channels.

As an example, the focal error LFF(Y_pred, Y_true, Y_aug) is such that:

$$LFF ( Y\_pred , Y\_true , Y\_aug ) = \sum {( ( dilate ( Y\_aug ) ) ⊙ ( Y\_pred - Y\_true ) )}^{2} , \qquad [ Math 2 ]$$

where dilate(⋅) defines a morphological dilation function, for example having a 5×5 circular kernel, and where the operator ⊙ corresponds to point-by-point multiplication. In particular, function dilate(⋅) enables to increase the radius of impact of the loss function in the vicinity of outlier pixels, then enabling to more easily correct effects due to large receptive fields of the convolutional neural network used to reconstruct the image.

As an example, the regularity error LR(Y_pred) is such that:

$$LR ( Y\_pred ) = TV ( Y\_pred ) , \qquad [ Math 3 ]$$

where TV(⋅) corresponds, for example, to the calculation of the total variation, or to a variant of the total variation. The use of the total variation as a regularization function is given as an example and is of course not limiting.

According to an embodiment, during the training of network 202, the obtained error value is backpropagated in network 202 in order to re-evaluate and update the parameters associated with network 202. As an example, the update of the parameters is performed by the implementation of a gradient backpropagation method based on the error value. Deep learning methods based on gradient backpropagation are known to those skilled in the art and are thus not described in greater detail herein.

According to an embodiment, the focal loss function has the role of indicating to network 202, during the backpropagation of the error, which pixels are highly noisy. As an example, coefficient λ_{LFF} is greater than coefficient λ_{LFM}.

FIG. 3 is a block diagram illustrating an architecture of network 202 configured to perform regression operations, according to an embodiment of the present disclosure.

As an example, once trained, network 202 is implemented in an image processing device. As an example, the processing device further comprises an imager (not shown) configured to capture image scenes based on a mosaic pattern such as for example one of the patterns 100, 102, 104, 108, or 110 described in relation with FIG. 1. As an example, the imager comprises one or a plurality of bad pixels, or dysfunctional pixels. As an example, the device is a camera, a camcorder, a smartphone, etc.

Once the training of network 202 is over, that is, at the end of the implementation of the training described in relation with FIG. 2 on a plurality of ground truth images Y_true, network 202 is for example configured to perform regression operations on an input image Y_in, replacing data Y_bad, for example comprising one or a plurality of bad pixels. As an example, the training is over at the end of the processing of a large number, for example at least 1,000, of ground truth images. In another example, the training ends when the learning algorithm converges, that is, when the error value becomes lower than a threshold value.

The regression operation performed by the trained network 202 then consists in generating a demosaiced and reconstructed image Y_out based a mosaiced input image Y_in, supplied for example by the imager. The trained network 202 then comprises, for example, sub-modules 204, 206, and 208, having their parameters set at the end of the training. The mosaiced image Y_in is then directly supplied to network 202, without passing through augmentation module 200. Similarly, the demosaiced and reconstructed image Y_out is not supplied to computing circuit 210. Augmentation module 200 and computing circuit 210 are not, for example, part of the processing device in which the trained network 202 is implemented.

The trained network 202 is then configured, for example, to perform regression, interpolation, denoising, and detection and correction operations on the bad pixels detected in input image Y_in and to generate the corrected image Y_out based on these operations. In particular, as a result of the training, the processing sub-module 204 of network 202 is for example configured to generate an intermediate data item Y_tmp by making a first estimate of the missing or noisy information, at least partly due to bad pixels.

As a result of the training, sub-module 206 is configured, for example, to generate an attention data item Y_pwa, based on input image Y_in and/or on intermediate data item Y_tmp. Sub-module 206 is then for example configured to detect, individually for each pixel, whether this pixel is a bad pixel or not. The success rate of the bad pixel detection depends, of course, on the training and on the level of expressivity, linked to its internal structure, of network 202. Sub-module 206 then generates a data item Y_pwa, comprising information on the detected outliers as well as on their location in input image Y_in. As an example, the detection is a multi-scale detection and data item Y_pwa provides a context, for example a category indication among, among others, a type of contour, texture, presence, and noise level and of positions of the outlier pixels, pixel by pixel.

As a result of the training, sub-module 208 is configured, for example, to generate the demosaiced image Y_out based on intermediate data item Y_tmp and on attention data item Y_pwa. As an example, sub-module 208 is configured to correct the areas identified, by data item Y_pwa, as being outside the main statistics, that is, as areas comprising one or a plurality of bad pixels.

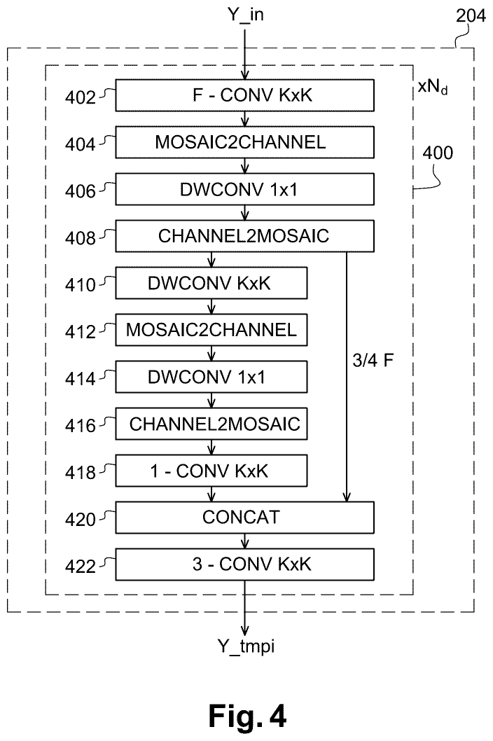

FIG. 4 is an example of the architecture of processing sub-module 204 according to an embodiment of the present disclosure.

As an example, sub-module 204 comprises a plurality of sub-networks 400. As an example, sub-module 204 comprises a number Nd, Nd being an integer greater than 2, preferably greater than or equal to 5 and smaller than or equal to 12, of sub-networks 400.

As an example, each sub-network 400 is configured to receive input image Y_in and to generate, each, an intermediate data item Y_tmpi. The Nd intermediate data items Y_tmpi are then concatenated, for example in the axis of the channels or in an additional axis.

Each sub-network 400 comprises, for example, a plurality of layers. As an example, input image Y_in is supplied to a convolutional layer 402 (F−CONV K×K). As an example, layer 402 is a two-dimensional convolutional layer with F output channels, F being an integer greater than or equal to the number of pixels in the mosaic pattern, and comprising kernels of K×K size, where K is an integer greater than the width and/or height of the mosaic pattern.

As an example, the output generated by layer 402 is supplied to a layer 404 (MOSAIC2CHANNEL). As an example, layer 404 is a so-called pixel shuffle layer, configured to spatially rearrange the channels from close to close to the data item supplied thereto. In particular, layer 404 is configured to perform a so-called “space-to-depth” operation. Further, the performed operation is parameterized by the size of the considered mosaic pattern.

As an example, the output generated by layer 404 is supplied to a layer 406 (DW CONV 1×1). As an example, layer 406 is a depthwise convolutional layer comprising kernels of 1×1 size, thus allowing an independent weighting of each channel.

As an example, the output generated by layer 406 is supplied to a layer 408 (MOSAIC2CHANNEL). As an example, layer 408 is a pixel shuffle layer, for example similar to layer 404.

As an example, the output generated by layer 408 is supplied to a layer 410 (DW CONV K×K). As an example, layer 410 is a depthwise convolutional layer comprising kernels of K×K size.

As an example, the output generated by layer 410 is supplied to a layer 412 (MOSAIC2CHANNEL). As an example, layer 412 is a pixel shuffle layer, for example similar to layers 404 and 408.

As an example, the output generated by layer 412 is supplied to a layer 414 (DW CONV 1×1) similar to layer 406.

As an example, the output generated by layer 414 is supplied to a so-called pixel shuffle layer 416 (CHANNEL2MOSAIC). In particular, layer 416 is configured to perform a so-called “depth-to-space” operation. Further, the operation performed is parameterized by the size of the concerned mosaic pattern.

As an example, the output generated by layer 416 is supplied to a layer 418 (1−CONV K×K). As an example, layer 418 is a two-dimensional convolutional layer with a single output channel and comprising kernels of K×K size.

As an example, a concatenation pooling layer 420 (CONCAT) is configured to perform a concatenation of the output data of layers 418 and 408. As an example, the output data from layer 408 is supplied to layer 420 via a so-called “skip connection”. The connection is then configured to supply, for example, ¾ of the output channels from layer 408 directly to layer 420.

The concatenation generated by layer 420 is for example supplied to a convolutional layer 422 (3−CONV K×K). As an example, layer 422 is a two-dimensional convolutional layer with three output channels and comprising kernels of K×K size. As an example, the three output channels are the three RGB color channels. Layer 422 is then configured to generate output data item Y_tmpi, corresponding to, for example, a first demosaicing and reconstruction of the input image.

As an example, data item Y_pwa is injected into the model of network 206 to calculate all or part of intermediate data item Y_tmp.

According to an embodiment, the parameters of the sub-networks 400 are learned during the training of network 202 described in relation with FIG. 2.

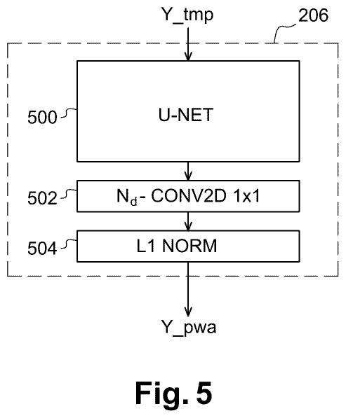

FIG. 5 is an example of architecture of attention module 206, according to an embodiment of the present disclosure.

Sub-module 206 having the task of detecting, pixel by pixel, bad pixels, an architecture used for image segmentation is adequate for the implementation of sub-module 206.

As an example, sub-module 206 then comprises a network 500 (U-NET) of U-net type. In other examples, network 500 is a type of network other than U-net configured to perform image-to-image operations. As an example, network 500 is a variant and/or an improvement of a network of U-net type. As an example, network 500 is further configured to implement internal attention mechanisms and/or to manipulate 2- or 3-dimensional data. As an example, network 500 further comprises a dense interconnection structure.

As an example, network 500 is a U-net network having a typical depth equal to 4 and comprising receptive field 5×5 convolution blocks with a ReLU-type activation. In an example, network 500 of U-net type is based on convolution blocks comprising two 3×3 convolutions per group, each followed by a channel shuffle. This example is specific and enables to limit the complexity of network 500 and to apply receptive 5×5 fields. Those skilled in the art will be capable of adapting and modulating the sizes of the receptive fields as well as the number of convolution groups. As an example, network 500 is also configured to further perform an subsampling operation, such as a so-called stride operation, for example implemented by a so-called MaxPooling layer. As an example, the subsampling is an subsampling by 2, corresponding to a 2×2 MaxPooling operation. As an example, network 500 further comprises normalization stages enabling to limit the impact of the absolute amplitude of the data on inference operations. In another example, when the absolute amplitude of the data is an element taken into account in bad pixel detection, network 500 comprises at least one non-normalized path. Skip connections are implemented by a pooling operation, for example a concatenation. As an example, an oversampling operation is implemented by a convolution having a stride size of 2.

As an example, network 502 is configured to supply the data item that it generates to a layer 504 (L1 NORM). Layer 504 is configured to normalize the received value, for example by application of a normalization performed along the channel axis and noted NL1. The application of normalization NL1 enables the sum of the Nd intermediate data to be equal to 1. As an example, the application of normalization NL1 is performed via a softmax or softargmax-type activation function. Indeed, the softargmax(⋅) function is equal to NL1(exp(⋅)). The argmax function thus also returns an output, having the sum of its elements equal to 1. Thus, the various reconstructions of intermediate data item Y_tmp are summed in normalized fashion. As an example, layer 504 is configured to receive a data item having the form of a tensor T∈R^{I×J×C}, I and J being, respectively, the number of rows and of columns of pixels in the image and C being the number of channels in the tensor. As an example, for module 204, values C and Nd are equal. By noting the value of tensor T at position [i,j] in the image and for a channel c, T[i,j,c], layer 504 is for example configured to normalize, for each position, the tensor performing the transformation:

$$NL 1 ( T [ i , j , c ] ) = T [ i , j , c ] / {\sum }_{c = 1}^{C} \vert T [ i , j , c ] \vert . \qquad [ Math 1 ]$$

Further, normalization NL1 is applied to positive data, derived from an activation function of network 500.

In another example, to avoid a potential division by 0, the norm L1 of the tensor at position [i,j] is defined as

$$NL 1 ( T [ i , j , c ] ) = T [ i , j , c ] / ( {\sum }_{c = 1}^{C} \vert T [ i , j , c ] \vert + ε ) , \qquad [ Math 2 ]$$

where ε is a real number, greater than 0.

In still another example, the normalization NL1 of the tensor at position [i,j] is defined as NL1(T[i, j, c])=0 or NL1(T[i, j, c])=1/C, if Σ_{c=1}^{C}|T[i, j, c]|<ε and NL1(T[i, j, c])=T[i, j, c]/Σ_{c=1}^{C}|T[i, j, c] | otherwise.

As an example, the output data item Y_pwa of module 206 then corresponds to normalization NL1, defined according to one of the above examples, of the tensor at the output of segmentation network 500.

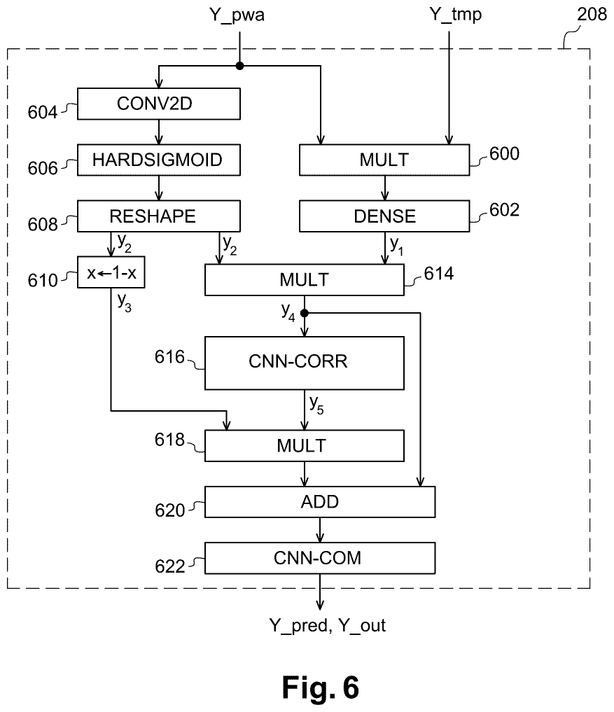

FIG. 6 is an example of the architecture of refinement network 508, according to an embodiment of the present disclosure.

As described in relation with FIGS. 2 and 3, sub-module 208 is configured to generate output Y_pred, during the training of network 202, or Y_out during the execution of the trained network 202. The input data are then used to infer the output data item. Data item Y_pwa is, for example, used to select the outputs Y_tmpi of the sub-networks 600. Data item Y_pwa is for example further used to indicate the type of processing, for example a gating, to be performed on the data item Y_tmp resulting from the first demosaicing and reconstruction performed by sub-module 204.

As an example, sub-module 208 comprises a layer 600 (MULT) configured to perform an operation of multiplication, for example pointwise, of tensor Y_tmp based on the values of attention tensor Y_pwa. In another example, layer 600 is configured to perform an operation of multiplexing of tensor Y_tmp based on the values of attention tensor Y_pwa. In the example where layer 600 is configured to perform a multiplexing operation, an activation function of module 206 is of argmax type. The output of layer 600 then is, for example, supplied to a dense layer 602. Dense layer 602 is then configured to generate an output Y₁ based on the data item supplied by layer 600. As an example, output Y₁ corresponds to a list of D linear combinations of the outputs of layer 600, thus generating a tensor of size W×H×N_{c}×D, where W is the pixel width of the image, H the pixel height of the image, and where Nc refers, for example, to the three color channels and where D is the dimension along axis 4 of the tensor. The value of D depends, for example, on the topology as well as on the hyperparameters of network 202.

Sub-module 208 further comprises a convolutional layer 604 (CONV 2D) configured to perform a convolution operation on tensor Y_pwa. The result of layer 604 is then supplied to a layer 606 (HARDSIGMOID). As an example, layer 606 is configured to apply an activation function, such as a HardSigmoid function, to the received data item.

Layer 606 is then configured to supply its output to a layer 608 (RESHAPE). For example, layer 608 is configured to resize the data item supplied by layer 606 into a tensor Y₂ of size W×H×Nc×D.

As an example, tensor Y₂ is supplied to a layer 610 (x<−1−x) configured to generate a tensor Y₃ by inverting, with respect to 1, the values of tensor Y₂. Tensor Y₂ and data item Y₁ are further supplied to a layer 612 (MULT) similar to layer 600. As an example, layer 612 is configured to generate a data item Y₄ based on data Y₁ and Y₂.

Data item Y₄ is supplied to a layer 616 (CNN-CORR). Layer 616 is, for example, a convolutional layer, or a cascade of convolutional layers, configured to generate a data item Y₅ of the defects detected by means of tensor Y_pwa. Thus, the portions of the input image being detected as requiring correction are smoothed.

Layer 616 is further configured to supply data item Y₅ to a layer 618 (MULT). Layer 618 is further configured to receive data item Y₃, supplied by layer 610, and to generate a data item Y₆ by performing an operation similar to that performed by layers 600, 612, and 614.

Sub-module 208 further comprises a layer 620 (ADD). As an example, layer 620 is an additional pooling layer. Layer 620 is for example configured to receive data item Y₄ and the data item at the output of layer 618 and to add them.

Sub-module 208 further comprises a layer 622 (CNN-COM) configured to generate output data Y_pred or Y_out based on the output of layer 620. As an example, layer 622 is a convolutional layer, or a cascade of convolutional layers, configured to shape the output data. As an example, the shaping comprises one or a plurality of rotations and/or colorimetric adjustments and/or smoothing and/or shifting operations, and so on.

According to an embodiment, the use of the HardSigmoid activation function enables an on/off-type detection of bad pixels and to perform an operation similar to a multiplexing by using multiplicative pooling layers and an additional pooling layer.

Various embodiments and variants have been described. Those skilled in the art will understand that certain features of these various embodiments and variants may be combined, and other variants will occur to those skilled in the art. In particular, regarding the types of the loss functions combined with the focal loss function, variants are possible. Similarly, the design, as well as the topology, of modules 204, 206, and 208 may vary.

Finally, the practical implementation of the described embodiments and variants is within the abilities of those skilled in the art based on the functional indications given hereabove. In particular, the practical implementation of a desired type of imager is within the abilities of those skilled in the art.

1. Method of training a neural network configured to perform image processing operations, the method comprising:
the generation of a modified image, by a modified data generator, based on a first image, the modified image comprising at least one outlier pixel value with respect to the first image;
the supplying of the modified image to the network;
the generation, by the network, of a corrected image;
the supplying of the corrected image, by the network, and the supplying of an indication of the position of the at least one modified pixel, by the generator, to a computing circuit
the generation of an error value, based on the application of a loss function, by the computing circuit, taking as inputs the first image, the indication, and the corrected image;
the correction of parameters associated with the network by backpropagation of the error in the network.

2. Method according to claim 1, wherein the generation of the corrected image by the network comprises:
the generation, by a first sub-module, of an intermediate data value based on the modified image, the intermediate data item being an at least partial reconstruction of the first image;
the generation, by a second sub-module of the network, of an attention data item based on one of the intermediate data item and/or of the modified image, the attention data item comprising an estimate of the location of the at least one modified pixel;
the generation of the corrected image, by the first sub-circuit or by a third sub-circuit, based on the intermediate data item and on the indication data item.

3. Method according to claim 2, wherein the generation of the attention data item comprises the execution of a convolutional neural network configured for image segmentation, based on the intermediate data item and/or on the corrected image.

4. Method according to claim 3, wherein the convolutional neural network is a U-net type network or a variant of a U-net type network.

5. Method according to claim 3, wherein the generation of the attention data item further comprises an NL1-type normalization, based on the data item generated by the convolutional neural network.

6. Method according to claim 2, wherein the generation of the corrected image comprises a multiplexing operation and/or a multiplication operation, for example a pointwise multiplication, based on the attention data item and on the intermediate data item.

7. Method according to claim 1, wherein the generation of an error value comprises the application of a focal loss function taking, as input data, the modified image, the first image, and the indication of the location of the at least one modified pixel.

8. Method according to claim 7, wherein the generation of an error value further comprises the application:
of a loss function based on an averaging taking, as input data, the modified image and the first image; and/or
of a regularization function taking, as an input data item, the modified image.

9. Method according to claim 1, wherein the first image is comprised in a database.

10. Method according to claim 1, wherein the generation of the modified image comprises, for each pixel:
the determination of whether the pixel is to be modified; and
if the pixel is to be modified, the replacing of the value associated with the pixel by an outlier.

11. Method according to claim 1, wherein the generation of the modified image, by the modified data generator, is further performed based on a mosaic pattern.

12. Method according to claim 1, wherein the model of the modified data generator is a neural network model previously trained in modified image generation, and configured for the implementation of so-called “style transfer” techniques.

13. Image processing method comprising:
the capture of an image scene, by an imager of an image processing device, the captured image being an image mosaiced according to a mosaic pattern
the supplying of the mosaiced image to a neural network of the processing device trained according to the training method according to claim 1; and
the generation of a corrected image, by the network, based on the mosaiced image.

14. Image processing method according to claim 13, wherein the generation of the corrected image by the network comprises:
the supplying of the mosaiced image to a first sub-module of the network configured to generate an intermediate data item by performing a first demosaicing of the mosaiced image;
the supplying of the intermediate data item to a second sub-module of the network configured to generate an attention data item based on the intermediate data item, the attention data item comprising estimates of the location of dysfunctional pixels of the imager; and
the generation of the corrected image, by a third sub-module, based on the intermediate data item and on the attention data item.

15. Image processing method according to claim 13, wherein the mosaic pattern corresponds to a mosaic pattern used during the generation of a modified image during the training of the network.

16. Image processing device comprising:
an imager configured to capture image scenes, according to a mosaic pattern;
a neural network trained according to the training method according to claim 1, configured to generate a corrected image based on the mosaiced image.

17. Image processing device according to claim 16 wherein the imager comprises one or a plurality of dysfunctional pixels.
